(19) United States
(12) Patent Application Publication
(10) Pub. No.: US 2002/0138554 A1
(43) Pub. Date: Sep. 26, 2002

(54) Method for remotely verifying software integrity

(75) Inventors: Ronald G. Feigen, Tempe, AZ (US); Richard A. Perona, Gilbert, AZ (US); James T. Lynn, Issaquah, WA (US); Erwin P. Comer, Queen Creek, AZ (US)

Correspondence Address: MOTOROLA, INC., CORPORATE LAW DEPARTMENT - #56-238, 3102 NORTH 56TH STREET, PHOENIX, AZ, 85018, US

(73) Assignee: Motorola, Inc.

(21) Appl. No.: 09/816,191

(22) Filed: Mar. 26, 2001

(51) Int. Cl. G06F 15/177; G06F 15/16

(52) U.S. Cl. 709/203; 709/220

(57) ABSTRACT

A method of verifying the integrity of software resident on a remote network appliance is disclosed. The method includes providing a secure hash algorithm coupled with a seed value that may be employed by a network host to verify the integrity of the software associated with one or more network appliances.

### TECHNICAL FIELD

The present invention relates, generally, to a method for remotely verifying the integrity of software resident on a client module and, more particularly, to a secure hash subroutine which incorporates at least one degree of randomness.

### BACKGROUND ART AND TECHNICAL PROBLEMS

Remote network appliances, such as cable television boxes, cellular telephones, satellite dishes, and even personal computer (PC) based local area networks (LANs) and wide area networks (WANs) are vulnerable to tampering by “hackers” because of the limited ability of the network host or service provider to control user access to the remote devices. More particularly, since the service provider (network host) cannot easily physically inspect the remote device, it is difficult to determine whether a remote device has been tampered with, for example, by a user to obtain unauthorized access to paid programming, software applications, toll free long distance access, or various other products and services offered by the network.

Although various security techniques have been developed to mitigate this type of unauthorized tampering, presently known integrity checks are unsatisfactory, largely because it is precisely the hacked system that controls the communication with the host; as such, a clever hacker can mask his tampering by responding to integrity checks initiated by the host in a manner which makes the tampering undetectable by the host. Exemplary prior-art techniques for mitigating unauthorized tampering of remote network appliances are disclosed in U.S. Pat. No. 5,003,591, issued to Kauffman et al. on Mar. 26, 1991; U.S. Pat. No. 5,195,130 issued to Weiss et al. on Mar. 16, 1993; and U.S. Pat. No. 5,572,572, issued to Kawan et al. on Nov. 5, 1996, the entire contents of each which are hereby incorporated herein by reference.

A technique for verifying the integrity of remote software in a network environment is thus needed which allows the host to unambiguously determine whether the integrity of remotely installed software has been corrupted by a user of the network device.

### BRIEF DESCRIPTION OF THE DRAWINGS

The present invention will hereinafter be described in conjunction with the appended drawing figures, wherein:

FIG. 1 is schematic block diagram of a memory map associated with a network appliance; and

FIG. 2 is flow chart illustrating a system integrity verification process in accordance with the present invention.

### DETAILED DESCRIPTION OF THE DRAWINGS

The present invention provides a secure hash algorithm coupled with a random seed value which may be employed by a network host to verify the integrity of software (e.g., applications, operating system, configuration file, or the like) associated with a plurality of remote network appliances served by the network host. The software integrity verification process of the present invention may be applied in the context of cable television set top boxes, paid programming television modules, cellular telephone networks, PC-based LAN/WAN networks or essentially any other wired or wireless network in which there is a need for the network host or service provider to monitor the configuration of the remote network appliances.

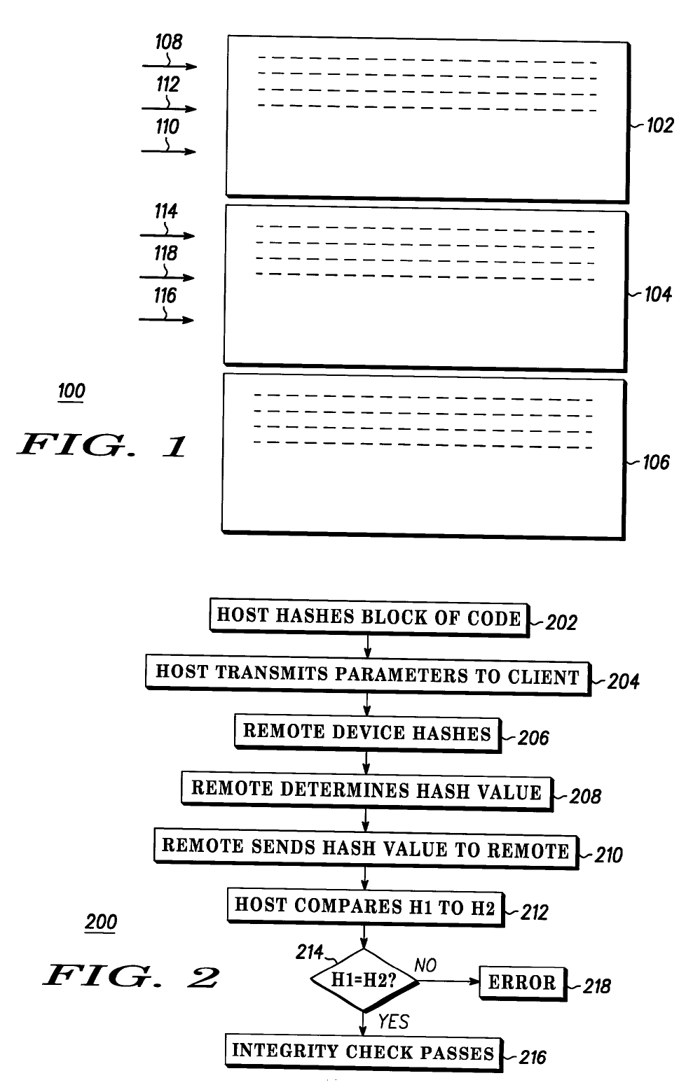

FIG. 1 schematically illustrates an address space 100 representing the memory resident in an exemplary remote network device, for example a television set top box. As shown in FIG. 1, address base 100 includes a plurality of logically discrete memory sectors. For example, a first memory sector 102 may correspond to static memory (e.g., flash, ROM, or the like) and a memory sector 104 which corresponds to, for example, random access memory (RAM). Address base 100 may also include one or more additional logical memory sectors, for example, a memory sector 106 corresponding to various input/output functions and protocols. In the context of the present invention, any number of memory sectors, corresponding to the various functions associated with the particular network appliance, may be employed.

The secure software integrity verification technique of the present invention requires at least limited bidirectional communication between the host and the various network appliances connected to the host. In order for the host to confirm that a block of code resident in the client device has not been tampered with, the host performs a hash function on a copy of the code under inspection which is maintained by the host. The host then transmits the hash function to the remote device whereupon the remote device performs the same hash function on the “same” block of code resident in the remote device. The remote device then transmits the resulting hash value back to the host, whereupon the host compares the initial hash value obtained by the host to the hash value received from the remote device. If the two hash values match, the host concludes that the block of code resident in the remote device corresponds to the copy of that same block of code maintained by the host. If, on the other hand, the two hash values do not match, the hosts may conclude that the block of code resident in the remote device has been tampered with or otherwise corrupted.

The present invention further contemplates the use of one or more random seeds which are generated by the host and inserted into the block of data under inspection. This random seed may be generated randomly, pseudorandomly, or may be drawn from any desired source such as a look-up table, database, or any other convenient parameter (e.g., time of day, temperature, stock market value, or the like). Moreover, it is not necessary that the entire address space of the remote device's memory be hashed; rather, it may be desirable to hash only certain discrete ranges of address space 100 inasmuch as the parameters defining the address spaces which are hashed may also be manipulated to enhance security.

Referring now to FIGS. 1 and 2, an exemplary implementation of the method in accordance with the present invention will now be described in the context of address space 100 (HG. 1) and process 200 (FIG. 2).

The network host first performs the hash function on a predetermined subset of the code resident in the remote device (step 202). As described in greater detail below, a random seed is inserted into the code under inspection prior to performing the hash function. The host then transmits various parameters to the remote device (step 204). In particular, the host transmits the hash value obtained by the host as a result of performing the hash function on the predetermined block of code. In addition, the host transmits the seed value to the client, as well as the ranges which define the subset of code and the particular address in the code at which the seed value was inserted.

More particularly, and with momentary reference to FIG. 1, the subset of code under inspection may correspond to the lines of code between a beginning address 108 and an ending address 110 associated with memory sector 102. The host also identifies an intermediary address 112 at which the random seed is to be inserted. The subset of code under inspection may also include that portion of memory sector 104 between a beginning address 114 and an ending address 116. In accordance with a further aspect of the present invention, an intermediary address 118 may also be defined by the host. In this regard, an additional value may be inserted at intermediate address 118, for example, another random value or any other bit or group of data. In a preferred embodiment, a running sum of the hash functions corresponding to the code spanning lines 108 and 110 is inserted at intermediary address 118. Thus, to the extent a random value is inserted at intermediary address 112, the running sum value inserted at intermediary address 118 will also be random.

Upon receiving the seed value, address range parameters, and any other necessary information from the host, the remote device performs the same hash function on the same subset of data (step 206). In this regard, the hash function may be transmitted from the host to the remote device or, alternatively, the hash function may remain resident at the remote device and called upon by the device when it is needed. In this way, only the seed value and address parameters need to be conveyed from the host to the remote device in order to allow the remote device to perform the integrity check.

Once the remote device has performed the hash function on the subset of code, the remote device determines the hash value associated with that computation (step 208). The remote device then transmits the hash value to the host (step 210). Upon receiving the hash value from the remote device, the host compares the hash value calculated by the host to the hash value calculated by the remote device, HI and H2, respectively (step 212). If the two hash values are equal (step 214), the host confirms that the code resident at the remote device has not been tampered with (step 216). If, on the other hand, the two hash values do not correspond (“NO” branch from step 214), the host notes the error (step 218). In this regard, the host may respond to such an error in any number of ways appropriate under the circumstances. For example, the host may rerun an additional integrity check, or the host may take appropriate action such as, for example, terminating the remote device's access to one or more applications, services, or the like. In addition, the host may notify the remote device of the discrepancy and attempt to reconcile the discrepancies between the copy of the code maintained at the host and the copy of the code maintained by the remote device.

Although the present invention has been described with reference to the drawing figures, those skilled in the art will appreciate that the scope of the invention is not limited to the specific forms shown in the figures. Various modifications, substitutions, and enhancements may be made to the descriptions set forth herein, without departing from the spirit and scope of the invention which is set forth in the appended claims.

What is claimed is:

1. A method (200) of verifying the integrity of software resident in a remote device in a network operated by a host, comprising the steps of:
providing a copy of the memory associated with said remote device to said host;
identifying, by said host, a subset of said memory associated with remote device;
inserting, by said host, a random seed at a predetermined address within said memory subset;
performing (202), by said host, a hash function on said memory subset containing said seed;
determining a host hash value as a result of said performing step;
transmitting (204) said seed and indicia of said memory subset from said host to said remote device;
inserting, by said remote device, said hash function on said memory subset containing said seed;
determining (208), by said remote device a remote hash value as a result of said executing step;
transmitting (210) said remote hash value from said remote device to said host; and
comparing (212), by said host, said host hash value to said remote hash value.

2. The method of claim 1, further comprising the step of determining a range that defines the subset of said memory

3. The method of claim 2, wherein the subset of code corresponds to code between a beginning address and an ending address, associated within a sector memory.

4. The method of claim 1, further comprising the step of identifying an intermediary address (112).
